(19) United States
(12) Patent Application Publication
(10) Pub. No.: US 2017/0061103 A1
(43) Pub. Date: Mar. 2, 2017

(54) System For Operating A Clinical Trial

(71) Applicant: eClinicalHealth Limited, Stirling (GB)

(72) Inventors: William D. Bain, Stirling (GB); Ian M. Mills, Winchester (GB)

(73) Assignee: eClinicalHealth Limited, Stirling (GB)

(21) Appl. No.: 15/206,099

(22) Filed: Jul. 8, 2016

(30) Foreign Application Priority Data
Jul. 10, 2015 (GB) 1512088.4

(51) Int. Cl. G06F 19/00; G06F 21/62

(52) U.S. Cl. CPC G06F 19/363; G06F 19/322; G06F 21/6245

(57) ABSTRACT

There is provided a system for operating a clinical trial, and a method for conducting a clinical trial using said system, wherein the system is capable of uniting all stakeholders in a single instance model. More particularly there is provided a paperless system for operating and management of data for a clinical trial which is capable of operating across different user levels, and is adapted to provide data to organisations in a variable hierarchical tiered environment, and which provides built-in privacy protection.

### FIELD OF THE INVENTION

The present invention relates to a system for operating a clinical trial, and to a method for conducting a clinical trial using said system, wherein the system is capable of uniting all stakeholders in a single instance model. More particularly the present invention relates to a paperless system for operating and management of data for a clinical trial which is capable of operating across different user levels, and is adapted to provide data to organisations in a variable hierarchical tiered environment, and which provides built-in privacy protection.

### INCORPORATION BY REFERENCE

This patent application incorporates by reference in its entirety patent application GB 1512088.4 filed Jul. 10, 2015, entitled “System For Operating A Clinical Trial”.

### BACKGROUND OF THE INVENTION

The substantial costs for pharmaceutical and biopharmaceutical companies for bringing new therapies to the market include many different aspects. In simplified form these can be broken down into three stages: the initial research and development (R&D) to provide a suitable form of the target pharmaceutical (pharma)/bio-pharmaceutical (biopharma) entity for testing in clinical studies (human trials); running a series of clinical trials; provided those trials are successful, seeking Regulatory Approval of the new therapy and production and distribution of the so-approved product for marketing.

It is generally accepted that in the pharma/biopharma sectors in particular delays in the development timeline which result in delays in product launch can lead to both impact upon the value of the developing Company (share price) both in the short term, and in the longer term, as a reduced period of exclusivity for recovery of the substantial development costs ultimately will have an impact on profitability.

Whilst the management of the time-lines and processes relating to the initial R&D phase are largely within the remit of the developing company, those relating to clinical trials are not. This is because clinical trials need to recruit human participants, whether as healthy volunteers for initial studies, or as patients having one or more conditions which are targeted by the new therapy to be tested.

Recruitment of clinical trial participants is often a major barrier to the feasibility and timely completion of clinical trials. Trial participation is often limited by geographical constraints due to the number of eligible participants who live near trial sites, especially for uncommon medical conditions. In addition, requirements for multiple visits to the clinical site, and/or a limited number of time slots can create both a funnel for trial enrolment and also interfere with compilation of the results of the trial i.e. completion of the trial on the projected time-line. This dilemma may be enhanced by fact that participants may not always be fully engaged in the clinical trial and therefore participant/volunteer/patient data may not be optimally obtained and/or processed.

Thus there is a need for a method for conducting a clinical trial using a system which is capable of overcoming the difficulties associated with engagement of participants in relation to trial-specific factors such as locations, and also reducing the potential for time-delays associated with participant engagement and resultant non-optimal data capture.

Whilst recent attention has focused upon monitoring of medical records and the transcription of those into Case Report Forms suitable for use in a clinical trial scenario, the Applicant has recognised that the information obtained from the primary source, the participant/volunteer/patient, could be improved via a clinical trial system which promotes improved engagement, particularly in the light of increasing complexity, which makes clinical studies burdensome for patients.

Given these operational challenges as well as the increasing demands on the time involved for the clinical trial site personnel to manage the data-relating to the trial, such as for example the use of a multiplicity of different electronic systems and different operating platforms can lead to a decreased interest from Clinical Trial Investigators (Cls) to participate in clinical trials. Additional challenges to study teams are the ability to consolidate both participation and maintenance of consistent quality across multiple sites.

Currently the major operational costs associated with conducting clinical trials are site-specific i.e. site management, payments, and participant monitoring. This is confirmed in Eisenstein, et. al. Reducing the costs of phase III cardiovascular clinical trials. Am Heart J 2005;149(3):482-8.

Thus there is a need for a method for conducting a clinical trial using a system which is: easier-to-use at all points of access, for all users, whether investigators, or participants; overcomes the data-quality/consistency issues associated with present-day systems; is capable of improving the control of operational factors in conducting clinical trials.

In parallel with the contemporary challenges of clinical research, trends are emerging in healthcare that are largely driven by the proliferation of information on the Internet which indicate that electronic communication and data acquisition may soon be becoming the standard in healthcare and the proliferation of health information on the Internet is giving rise to the “e-patient”—a patient who is engaged, empowered, and online. As confirmed by Fox and Duggan in Health Online 2013, Pew Research Center's Internet & American Life Project, Jan. 15, 2013, available at: http://www.pewinternet.org/2013/01/15/health-online-2013/online.aspx and incorporated herein by reference, in 2012, 59% of US adults searched for health information online.

The widespread use of mobile phones has decreased socio-economic and age barriers to web access, Smith A. Mobile Access 2010. Pew Research Center's Internet & American Life Project. Jul. 7, 2010. Available at: http://www.pewinternet.org/2010/07/07/mobile-access-2010/ and included herein by reference.

In addition groups of patients with common medical conditions and concerns are also organizing online to share data and initiate research activities.

In light of these trends, there have been attempts to more effectively capture electronic data capture from health records, laboratories, patient reported outcome, clinical devices and other sources. These attempts have encountered difficulties because they require, in most cases, the use of multiple platforms and often the data-generated also requires manual transfer between different systems with a concomitant significant risk of human-data entry errors.

Thus there is a need for a method for conducting a clinical trial using a system which is compatible with “e-patient” access and at one and the same time overcomes the issues relating to use of multiple platforms associated with current systems.

Clinical trial technologies typically break down into specific functional areas, such as, for example, patient facing electronic patient reported outcome (ePRO), site and sponsor facing Electronic Data Capture (EDC), Clinical Trial Management and Drug Safety systems. Each of these functional areas can be regarded as a bespoke data capture solution for a discrete amount of targeted data. These solutions are developed with varying methods used to present forms i.e. both static internal forms as well as metadata based forms which are spread across one or more products. The result of using these solutions is a static product which requires software developer dependent modifications to the forms and the logic between the forms.

Many attempts have been made to provide point solutions e.g. electronic health records, electronic informed consent solutions or electronic case report forms suitable for use in clinical trials.

The Applicant has recognised that such limited static-point solutions are merely operational tools for use in speeding up or improving aspects within the current methods for conducting clinical trials.

The Applicant has also recognised that the current clinical trial paradigm is incapable of incorporating means for sustainable innovation. In particular the Applicant has recognised that there is a need for a more efficient method for running clinical trials to reduce their current cost, improve timelines and optimize data quality.

There is presently no method for conducting a clinical trial using a system for operating the trial which allows controlled, direct, real-time access to the relevant data for all stakeholders in the clinical trial, participants, clinical site investigators, sponsors and auditors.

It is an object of the present invention to provide a method for conducting clinical trials which overcomes the issues of the current systems, and in particular the provision of an efficient and effective method which is capable of delivering reductions in the costs of running clinical trials, improving the time-frames from initiation to completion of clinical trials, and providing optimal data quality.

It is an object of the present invention to provide a method for conducting a clinical trial using a system which is capable of overcoming the difficulties associated with engagement of participants in relation to trial-specific factors such as locations, and also reducing the potential for time-delays associated with participant engagement and resultant non-optimal data capture.

It is an object of the present invention to provide a method for conducting a clinical trial using a system which is: easier-to-use at all points of access, for all users, whether investigators, or participants; overcomes the data-quality/consistency issues associated with present-day systems; is capable of improving the control of operational factors in conducting clinical trials.

It is an object of the present invention to provide a method for conducting a clinical trial using a system for operating the trial which is capable of uniting all stakeholders in a single instance model to allow controlled, direct, real-time access to the relevant data for all stakeholders in the clinical trial, participants, clinical site investigators, sponsors and auditors.

### SUMMARY OF THE INVENTION

According to a first aspect the present invention provides a novel method for conducting a clinical trial using a system for operating the trial wherein the system is adapted to:
a) receive information;
b) obtain input information in a pre-determined data structure; and
c) extract information from the input information within the data structure in order to draw an inference;
   wherein the system is capable of uniting all stakeholders in a single instance model via utility of a combination of software, metadata and data wherein the system is capable of providing bespoke levels of privacy and security to one or more designated stakeholders all within a common single software instance and a common single database for all designated users, wherein users include patients, clients and stakeholders.

According to another aspect the present invention provides a novel method for conducting a clinical trial using a system for operating the trial in accordance with the first aspect wherein the system provides a single system for all messaging, workflow and/or materials between stakeholders [patients, sites and/or sponsor(s)] in a clinical trial.

According to a further aspect the present invention provides a novel method for conducting a clinical trial using a system for operating the trial in accordance with the first aspect or other aspect wherein the system is a domain specific platform and wherein clinical trial data can be accessed in real-time from the platform by the stakeholders in accordance with the bespoke privacy and security settings.

According to yet further aspects the present invention provides a novel method for conducting a clinical trial using a system for operating the trial in accordance with any of the other aspects detailed herein wherein the system provides a dynamic organizational hierarchy supporting the acquisition of data, and in addition wherein the system is capable of providing hierarchical instantiation of metadata across trials and organizations.

In accordance with further aspects still the present invention provides a novel method for conducting a clinical trial using a system for operating the trial in accordance with any of the other aspects detailed herein wherein the system provides privacy protection for patient private data within the overall clinical trial data set as utilised by and accessible by sites and sponsor(s), and in addition wherein the system is capable of automatic redaction of patient private data any and all output formats including, but not limited to data capture forms, reports, data extracts and data integrations.

According to another aspect the invention provides a method for conducting a clinical trial using a system as defined in accordance with any of the other aspects herein and wherein the system architecture comprises the following components:
(i) one or more organisational components wherein each organisational component is configured to receive input from system, sponsor, collaborator, trial, document, and site components;
(ii) one or more sponsor components wherein each sponsor component is configured to receive/obtain input from one or more trial components, and wherein each sponsor component is configured to convert at least a portion of such input for extraction/access by the one or more organisational components;
(iii) a system component configured for data extraction/access by the one or more organisational components;
(iv) a trial component configured to receive/obtain input from one or more trial components and configured for data extraction/access by the one or more organisational components;
(v) one or more site components configured to provide input to one or more organisation components;
(vi) one or more user components linked to a document component; and
(vii) one or more family tree components linked to a document component.

These and further aspects are discussed in detail hereinafter.

### DESCRIPTION

As indicated hereinbefore the current state of technology typically in use within major pharmaceutical companies to support clinical trials is neither capable of providing the longed-for improvements in trial cost and time efficiencies, or of supporting forward-looking flexibilities for real-time data-capture/access across the board for trial stakeholders. For example, and as illustrated in FIG. 1 hereinafter a single clinical trial will often utilize as many as 10 different and independent operating platforms, with the Clinical Site Investigators needing to operating 4 or 5 (or more) of these and also with selective provision of required platforms to one or more trial sites and also to patients participating in the trial as necessary.

Such systems can be classed as utilising “silo” technologies i.e. several independent platforms, each capable, of performing a bespoke function related to the overall clinical trial outcome. As not every stakeholder in the clinical trial will require access to each platform all of the time, some of the time, or at all, this can create complex information/data-management and platform access scenarios. In the example illustrated in FIG. 1 different data and software silos that require interfacing and training are shown. This need for interfacing and training creates inefficiencies with duplicate copies of data and metadata.

As indicated hereinbefore this traditional model has well-recognised issues in relation to efficiency and costs and is not sufficiently flexible or capable of accommodating the increasing needs for fast-reliable information in real-time.

The Applicant has developed a novel method for conducting clinical trials which overcomes the issues associated with the present day systems, via use of a system for operating a clinical trial which is based on a domain specific platform that provides a single instance model for uniting all stakeholders within a multi-tenanted environment. The domain specific platform used in the system for use in the present method is capable of supporting of the whole lifecycle of a clinical trial with all forms, workflow and messaging being based on configurable settings.

A general illustration of the present platform is provided in FIG. 2 where the example platform has Forms, Workflow and Messaging components, which when applied, create data that can be reported and analysed.

The present invention provides a novel method for conducting a clinical trial using a system for operating the trial wherein the system is adapted to:
a) receive information;
b) obtain input information in a pre-determined data structure; and
c) extract information from the input information within the data structure in order to draw an inference;
   wherein the system is capable of uniting all stakeholders in a single instance model via utility of a combination of software, metadata and data wherein the system is capable of providing bespoke levels of privacy and security to one or more designated stakeholders all within a common single software instance and a common single database for all designated users, wherein users include patients, clients and stakeholders.

Use of the domain specific platform provides the means for the execution of entirely paperless clinical trials through the support for an indeterminate number of types of metadata driven forms in electronic format that can be routed and communicated via action aware messages with the capability of providing real-time status reports. The system is suitable for single, multisite and virtual trials and in one embodiment can build up a patient or volunteer registry for subsequent trials.

According to an aspect the present invention provides for use of a novel method for conducting a clinical trial in accordance with any one or more of the aspects detailed herein for establishment of a patient or volunteer registry.

The methods for conducting a clinical trial in accordance with any of the aspects detailed herein can be used to conduct any clinical trial. Typical clinical trials which can be conducted using the present methods include: a single-site trial; a multi-site trial or a virtual clinical trial wherein such trial ranges in size from an investigator sponsored trial (IST), up to a Mega-trial having two or more organisational tiers. For the avoidance of doubt sites and sponsors constitute organizations, and as such represent independent organisational tiers.

According to an aspect the present invention provides for use of a novel method for conducting a clinical trial in accordance with any one or more of the aspects detailed herein wherein the clinical trial is independently selected from: a single-site trial; a multi-site trial or a virtual clinical trial wherein such trial ranges in size from an investigator sponsored trial (IST), up to a Mega-trial having two or more organisational tiers.

In addition, given the overarching need to ensure patient-identifying information remains confidential and the multiplicity of stakeholders accessing information/inputting data into the current systems, as illustrated in FIG. 1, and as discussed herein, the Applicant has recognised that the current systems are not capable of eliminating the risk of confidential information being accessible to unauthorised stakeholders.

Thus there is a need for a method for conducting a clinical trial using a system which is capable of providing privacy protection for patient private data, and particularly for a system capable of redacting such data under appropriate circumstances.

According to an aspect the present invention provides a novel method for conducting a clinical trial in accordance with any one or more of the aspects detailed herein using a system for operating the trial wherein the system is adapted to:
a) receive information;
b) obtain input information in a pre-determined data structure; and
c) extract information from the input information within the data structure in order to draw an inference;
   wherein the system is capable of uniting all stakeholders in a single instance model via utility of a combination of software, metadata and data wherein the system is capable of providing bespoke levels of privacy and security to one or more designated stakeholders all within a common single software instance and a common single database for all designated users, wherein users include patients, clients and stakeholders.

For the avoidance of doubt the software herein is software is a single product with the metadata differentiating its uses.

Advantageously the present method provides for the first time a common platform for all participating user roles (from Patient to Sponsor) in a clinical trial research environment with built in privacy protection.

According to a further aspect the invention provides a method for conducting a clinical trial as defined herein wherein the system provides privacy protection for patient private data within the overall clinical trial data set as utilised by and accessible by sites and sponsor(s).

According to an aspect the invention provides a method for conducting a clinical trial as defined herein wherein the system capability for provision of privacy protection for patient private data within the overall clinical trial data set as utilised by and accessible by sites and sponsor(s) is via automatic redaction of patient private data any and all output formats including, but not limited to data capture forms, reports, data extracts and data integrations.

Advantageously the present method provides for the first time a single common platform for all organizations involved in a clinical trial in a variable hierarchical tiered environment.

According to a further aspect the invention provides a method for conducting a clinical trial as defined herein wherein the system provides a dynamic organizational hierarchy supporting the acquisition of data, and in particular wherein the system is capable of providing hierarchical instantiation of metadata across trials and organizations.

As indicated hereinbefore one of the particular issues with the current clinical trial paradigm is the relative inflexibility of the management systems, both internally and externally. This issue has been resolved by the method of the present invention in which the system provides a single forms, workflow and messaging environment that is used both internally within the product for administration functions as well as externally, on a configured basis, for specific implementations of the product to support clinical trials. This provides a means to allow forms, messages and workflow to be adapted without recourse to custom software development or platform modifications. This in turn results in a simplification and an increased flexibility in how a single instance/multi-tenant platform may serve the varying functional demands of different research organizations and deployment models.

The method for conducting clinical trials using the present operating system in accordance with the present invention represents a significant improvement to the current clinical trial paradigm.

In particular, the 2-layer concept of the platform where elements of the platform can be re-used in form factors allows for the main structure to remain unchanged for an infinite number of clinical trials while overlaying modules can be built to accommodate specific study needs. This enables the system to be flexible, allowing for rapid configuration and convenient for all users. A common workflow and messaging environment ensures consistency and completeness of communications.

In addition, the flexible hierarchical nature of the data constructs supports varying sizes of studies from the smallest Investigator Sponsored Trials (IST) through to mega trials with multiple organizational tiers (e.g. Sponsor Global, Sponsor Country, contract research organisation (CRO), site management organisation (SMO), Site, Patient).

The platform also provides a single system that greatly facilitates the conduct of clinical trials as all authorised users can access all clinical trial data in real-time in one location.

A further advantage provided by the use of the present method is that the system provides multi-purpose referential routable forms integrated with a single messaging and workflow environment.

In accordance with another aspect the present invention provides a method according to any one or more of aspects as detailed herein wherein the system architecture comprises the following components:
(i) one or more organisational components wherein each organisational component is configured to receive input from system, sponsor, collaborator, trial, document, and site components;
(ii) one or more sponsor components wherein each sponsor component is configured to receive/obtain input from one or more trial components, and wherein each sponsor component is configured to convert at least a portion of such input for extraction/access by the one or more organisational components;
(iii) a system component configured for data extraction/access by the one or more organisational components;
(iv) a trial component configured to receive/obtain input from one or more trial components and configured for data extraction/access by the one or more organisational components;
(v) one or more site components configured to provide input to one or more organisation components;
(vi) one or more user components linked to a document component; and
(vii) one or more family tree components linked to a document component.

In accordance with a further aspect the present invention provides a method according to any one or more of aspects as detailed herein wherein the system architecture comprises the following additional component, one or more collaborator organizational components wherein each collaborator organizational component is configured to receive input from a pre-defined set of organizations wherein the pre-defined set includes one or more sponsors and/or sites.

A collaborator organization as defined herein is typically an organisation intermediate between one or more sponsors and one or more sites. As such a collaborator organization typically has access to a set of organizations (generally sites). Collaborator organizations are non-hierarchical, where more than one collaborator organisation is present, each collaborator will have independent access to a pre-defined and different matrix of organizations they will work with.

Core Components

The following list of core components is a non-exhaustive list of the potential uses for the forms/workflow/messaging based on metadata within the single platform system for the operation of a clinical trial in accordance with the method of the present invention.

Forms

The forms element of the system for the operation of a clinical trial in accordance with the method of the present invention provides a multi-media rich environment including support for the embedding of video's, pictures, documents, labels, fields.

In accordance with a further aspect the invention provides a method for conducting a clinical trial using a single common platform system wherein the system is capable of supporting the definition and deployment of multiple form types.

Any form which is suitable for use in a clinical trial may be defined, deployed and supported by the present system.

Exemplary form types which the present system is capable of supporting are independently selected from one or more of:
Protocol Representation Forms, both for Patients (simple) and for Physicians (technical);
Pre-Screening forms, to assess a patients potential eligibility to participate in a trial;
Patient Questionnaires, to capture ePRO data directly from a patient;
eCRF, to capture clinical trial data from the sites;
ePRO, electronic Patient Reported Outcomes (Web based);
Suspected Unexpected Serious Adverse Reactions Reports (SUSARs);
(Serious)/Adverse Event Report forms;
Electronic Informed Consent forms, to provide information to patients, and to capture their consent to participate in a study;
eLearning Content, to provide information to users and to confirm knowledge through assessed Questions and Answers;
eLearning Certificates & Records;
Site Questionnaires to assess investigator site capabilities prior to taking part in a clinical trial; and
Site contract documents;

According to a yet further aspect there is provided a method, in accordance with any one or more of the aspects defined herein wherein the system includes a user definable forms platform which enables messages and/or workflows to be designed in accordance with the requirements of the clinical trial.

Workflow

The workflow element of the system for the operation of a clinical trial in accordance with the method of the present invention provides the means to control and route access to documents or parts of documents based on information that is derived or entered on any other document without recourse to custom software development. This applies both within and out with a study. Access restrictions apply to individual users (e.g. eLearning modules based on constraints that are user specific) as well as across users per site or patient.

In accordance with a further aspect the invention provides a method for conducting a clinical trial using a single common platform system wherein the system is capable of controlling and routing access to documents or parts of documents based on information that is derived or entered on any other document without recourse to custom software development.

Any information which is derived or entered onto any document may be controlled and routed by the present system.

Exemplary access restrictions which the present system is capable of controlling and routing include from one or more of:
Restricting access to other documents/eLearning until eLearning module satisfactorily completed;
Restricting access to study events except where pre-conditions met;
Restricting access to questionnaires until a time or value condition has been met;
Providing access to documents based on pre-determinate conditions and states to roles; and
Providing interaction with messaging ensuring entity (Documents or Patients) states reflect position in workflow states.

Messaging

The messaging element of the system for the operation of a clinical trial in accordance with the method of the present invention provides the means to provide messages to users to flag up their requirement to complete an activity on a form including eLearning, Data capture or Data Review, as well as provision of a pre-determined role base messaging environment assuring the regulatory integrity of the trial whilst maintaining an environment to assist in communicating ‘to do’ tasks.

In accordance with a further aspect the invention provides a method for conducting a clinical trial using a single common platform system wherein the system is capable of provide messages to users to flag up their requirement to complete an activity on a form including eLearning, Data capture or Data Review.

In accordance with a further aspect the invention provides a method for conducting a clinical trial using a single common platform system wherein the system is capable of provision of a pre-determined role base messaging environment assuring the regulatory integrity of the trial whilst maintaining an environment to assist in communicating ‘to do’ tasks.

Cross Functional Attributes

Metadata Instantiation

To facilitate the rapid preparation of the system as well as the enforcement of standards across organizations, the platform provides the mechanism for hierarchical metadata instantiation allowing definitions of metadata (for example Forms) to be available for adaption and extension at levels below the parent organization in a hierarchy. Such instantiation provides support for both Mandatory and Optional entries helping to assure standards compliance where necessary. The instantiation extends to other areas of the platform including, but not limited to Workflow, Role and Data structure definitions. The standardization of these elements is designed to enhance the referential quality and comparability of data between phases, across programs and potentially across therapeutic area.

Calculations

Provide a means to calculate values or statuses based the entry of values in the same or different forms.

Branching Logic

Through the provision of a Boolean constraint mechanism provide the means to hide or inactivate blocks of form elements, including whole forms, ensuring that only the elements necessary to be captured based on referential rules across forms are available for entry. These rules can be role specific.

Cross-form Data Validation Rules

The provision of workflow and logic supporting the flagging and messaging for data that falls out with pre-determined constraints.

Data Storage

The application secured and protected storage of data includes both patient private as well as site and sponsor data with access managed based on organizations and roles.

System Platform

The platform has been designed to provide an environment for all forms, workflow and messaging that are necessary to support a clinical trial. To achieve this, the platform provides a general-purpose method of storing data and for that data to be referential across the platform.

In particular, the platform is a domain specific platform allowing for 4GL (Fourth Generation Language) like construction of metadata based Forms, Workflows, or Messages compliant with Clinical trials regulations fully leveraging the single instance, multi-tenanted cloud architecture.

A domain specific aspect of the platform is the awareness that the platform maintains and manages regarding the electronic redaction of information which is not suitable for sharing with other parties. For example, the platform will automatically (and visually) redact patient private data from all data represented to user roles (such as sponsors) regardless of the method used to access that data (Reports/Forms/API).

Through the provision of a single common referential platform all data entered may be combined and compared with other data across the entire lifecycle of a clinical trial.

According to a yet further aspect still there is provided a method, in accordance with any one or more of the aspects defined herein wherein any data entered into the system can be combined and compared with any other defined data set within the complete lifecycle of trial data available at the time of the combination/comparison request.

According to a yet further aspect still there is provided a method, in accordance with any one or more of the aspects defined herein wherein the system includes a user definable forms platform which enables messages and/or workflows to be designed in accordance with the requirements of the clinical trial wherein the forms, workflow and messaging are based on configurable settings.

Definitions

Patient/participant/healthy volunteer privacy as defined herein means the protection of the privacy of individuals participating in a clinical trial via prevention of access to individual patient data (IPD) which could identify them. It is typically a condition of participation in a clinical trial that the individual is assured that their identify will be protected i.e. their identifying details will only be accessible to selected people, usually the team responsible for organising the site where the individual is participating, and potentially the principal investigator overseeing the trial. It is also typically an expectation of the participants that their identifying data would be used only for the purposes of contacting them in relation to recruitment, screening and other aspects of the clinical trial. Examples of identifying data, such as for example, their name, address, telephone numbers and/or date of birth (DOB), or their unique identifying number for healthcare in the country in which the trial is being run, such as their NHS number in England, or their CHI number in Scotland. Further forms of potentially identifying data include family member information.

Users as defined herein are those who potentially require access to the system for operating a clinical trial in accordance with the present method, independent of whether they require full-time 24/7 access, intermittent access, limited access or any other access rights. Exemplary users include users include patients/participants, clients, stakeholders.

Specified users as defined herein are those whose details are not subject to patient/participant/healthy volunteer privacy restrictions and whose details can be viewed by all users with appropriate access permissions. Specified users are any non-patient users and include sponsor users who work for a sponsor organization. For example, an administrator at that sponsor organization would typically have access to all of the users at that sponsor organization, and can change the users details appropriately. Most specified users can change their own details. Patients are unique because of the need for privacy. They have a hidden user record, with all of their actual details on forms where the privacy restrictions are enforced by the platform.

Sites, or clinical trial sites, as defined herein are the physical locations of the management functions for a particular arm of a study. For example, a multi-site study may be running with recruitment of participants by investigators based in different hospitals, each of which may be in a different country. Each hospital would considered a “site”.

Sponsors are the organisations that have identified a clinical query which needs to be answered and have designed a clinical trial to seeking the necessary information/data to resolve their query. In the majority of cases sponsors are multi-national pharma or bio-pharma companies with potential new therapies which require validation via a regulated clinical trial process, from volunteer studies through Phase I, Phase II and Phase III trials.

Investigators are the site-based clinicians responsible for overall recruitment and running of individual sites. In some cases, a single investigator may be responsible for multiple-sites, such as for example where the therapeutic indication is rare and the patients/participants are spread-over a wide area.

An instance, in object-oriented programming (OOP), is a specific realization of any object. Single instance as defined herein means that only one copy of the software and a single database exist for all stakeholders for all core platform functions. For example, forms are manifested by the platform using common code that exists once that in turn store data in a single database. Most specifically, single instance refers to the manifestation of different modules and functionality (EDC/ePRO/eLearning) using the same software and database.

Multi-tenancy as defined herein means a system architecture in which a single instance of a software application serves multiple users wherein each user is defined as a tenant. Where appropriate some tenants, such as perhaps the sponsoring organization in a clinical trial, may be provided with the flexibility/ability to customize limited aspects/parts of the application, such as color of the user interface (UI) or modification of certain rules of practice which are commensurate with the specified trial requirements. The code of the application remains untouched and inaccessible to the tenants.

Multi-role as defined herein refers to the ability to define multiple roles that controls access to system functionality, data and metadata. Users can be assigned to one or more roles for one or more trials or a single role for the system in general that applies outwith the scope of a trial.

Trusted third party, or gatekeeper, is an individual or entity provided with access to information/data generated during, or collected as part of the clinical trial process which has not been made available to the public, either because it relates to IPD, or because the particular clinical trial was run at a time prior to the present-day publication of information requirements. For example, new researchers may want to use IPD to verify results, carry out new analyses or answer new research questions. It is generally accepted that use of a trusted third party limits the risk of identification, or re-identification of participants, as well as protecting the commercial interests of the original sponsors of the trail in question.

A registry as defined herein is a database, also known as a data bank, which is comprised of information obtained from individuals participating in a clinical trial. This information is collected in a standardized way so that it can be used for the research purposes, primarily for which the particular trial has been designed, but also for future research purposes.

Clinical trials, also known as Clinical studies, Clinical protocols, or Clinical research studies are research studies in which real people participate. This participation can be as a patient with a condition for which a new treatment is being developed, or as a healthy volunteer. Clinical trials or protocols are a means of developing new treatments and medications for diseases and conditions. Clinical trials can include trials carried out on potential new drugs in preparation for a regulatory submission, trials on any medical interventions whether these are drugs, devices or procedures, as well as other investigations involving people conducted for research purposes such as sleep or psychology studies.

A volunteer, more commonly referred to as a healthy volunteer or Clinical Research Volunteer is a subject with no known significant health problems who elects to participate in research to test a new drug, device, or intervention.

Recruitment as defined herein means the process by which potential participants, patients, volunteers are identified, pre-screened and/or screened and ultimately consent to enrol for participation in a clinical trial.

Engagement, as defined herein means the controlled interaction with patients during the course of a clinical trial to encourage their appropriate participation through the provision of site or ethics approved information and bi-directional communication.

Retention, as defined herein means achieving the continued inclusion of patients throughout a clinical trial.

Data collection, or data-acquisition or data capture, as defined herein is the means by which the present system collects information/data generated throughout the operation of a clinical trial.

Electronic Data Capture (EDC) as defined herein means the use of the systems to collect/capture data generated throughout the operation of a clinical trial data in electronic form.

Patient diaries as defined herein include physical and electronic means by which the patient/volunteer/participant in a clinical trial records their condition, such as for example their symptoms, their responses to treatment/therapy/medication and how it affects their quality of life (QOL). Such diaries can also be used to record compliance with the therapy i.e. dates/time/frequency of taking medication.

Electronic patient-reported outcome (ePRO) is a patient-reported outcome which has been acquired via electronic means, such as for example and electronic patient diary.

Virtual trial as defined herein means a clinical trial that relies solely on electronic rather than face-to-face encounters between investigators/researchers/trial-sites and patients/participants/volunteers.

Direct to patient in a clinical trial this means the sponsor is able to go directly to a patient for their involvement and participation in a clinical trial. Using the method for conducting a clinical trial using the present system direct to patient from a sponsor to a patient can be achieved through privacy protection and site support.

FDA CFR 11 is the guidance from the US Food and Drug Administration (FDA) current regarding the scope and application of part 11 of Title 21 of the Code of Federal Regulations; Electronic Records; Electronic Signatures (21 CFR Part 11).

HIPAA is The Health Insurance Portability and Accountability Act (HIPAA) Privacy Rule which established the conditions under which protected health information (PHI) may be used or disclosed by covered entities for research purposes. The HIPAA Privacy Rule also defines the means by which individuals will be informed of uses and disclosures of their medical information for research purposes, and their rights to access information about them held by covered entities.

eCRFs, Electronic Case Report Forms are typically use by site personnel to capture data required in a clinical trial. A single set of CRF pages (typically 25-80 pages) are completed for each patient in a trial.

ePRO, Electronic Patient Reported Outcomes is a mobile device solution for capturing clinical trial data directly from a patient.

SUSARs, Suspected Unexpected Serious Adverse Reactions.

Family tree refers to an instantiation of an organizational hierarchy.

### BRIEF DISCUSSION OF FIGURES

FIG. 1: is a representation of how independent ‘silo’ technologies are currently used to run clinical trials.

FIG. 2: is a representation of the basic architectural components of the system for operating a clinical trial in accordance with the present invention.

FIG. 3: is a representation of the Document model entity relationship within the system for operating a clinical trial in accordance with the present invention.

FIG. 4: is an Entity diagram for the metadata which describes the Document within the system for operating a clinical trial in accordance with the present invention.

FIG. 5: is a representation of the Entity relationships to support Workflow/Messaging components within the system for operating a clinical trial in accordance with the present invention.

### DETAILED DESCRIPTION OF FIGURES

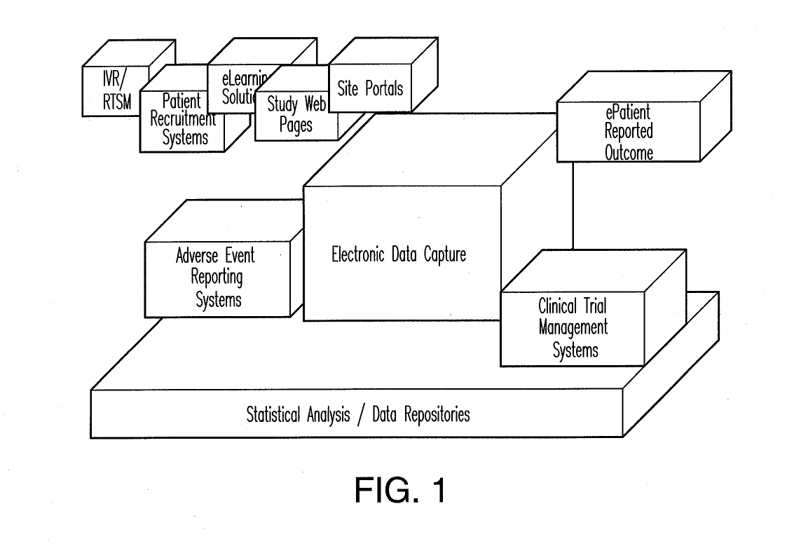

FIG. 1: illustrates the current state of technology typically in use within major pharmaceutical companies to support clinical trials. In FIG. 1 each of the different exemplary platforms are identified via an indication of their function i.e. Adverse Event Reporting Systems. In FIG. 1, each of these platforms, IVR/RTSM; Patient Recruitment Systems; eLearning solutions; Study Web Pages; Site Portals; ePatient Reported Outcomes; Adverse Event Reporting Systems; Electronic Data Capture; Clinical Trial Management Systems; and Statistical Analysis / Data Repositories is represented as a discrete “block”.

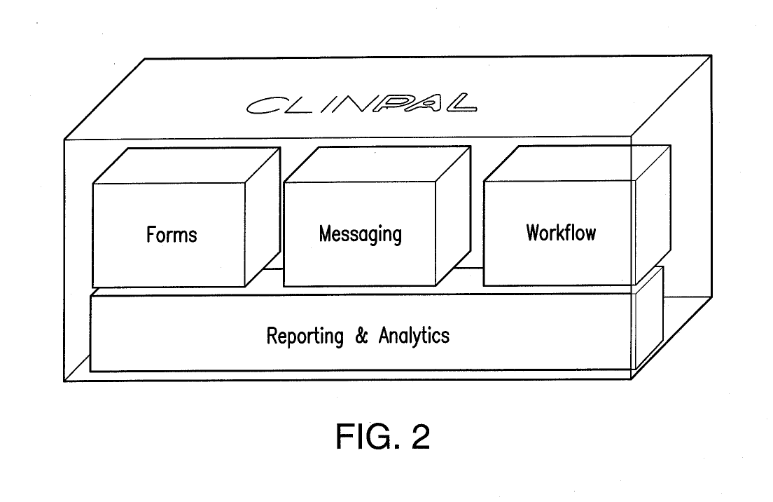

FIG. 2: illustrates the key architectural components of the system for operating a clinical trial in accordance with the method of the present invention. In particular FIG. 2 illustrates the underlying principle of applying Forms, Messaging and Workflow with Reporting & Analytics inside a Clinical Research aware platform setting. As discussed herein application of these components in the system used in the present method overcomes the issues associated with the current methods for conducting clinical trials. In FIG. 2, the common platform setting “CLINPAL” encompasses the four key components within the system, three of which Forms, Messaging and Workflow are each directly related to the Reporting and Analytics component.

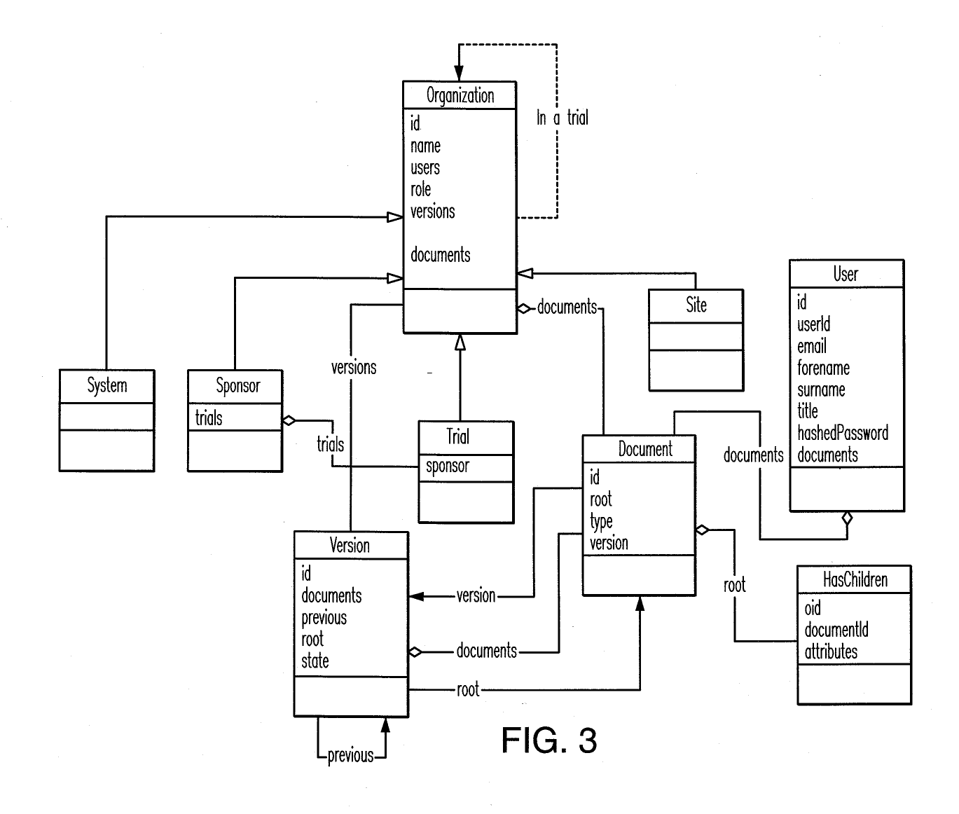

FIG. 3: Illustrates the relationships between various entities involved in a clinical trial, and in particular stakeholder access to documents (Sponsor, User), between information utilised in documents (Has Children/Version) and organisation of documents relating to a clinical trial conducted in accordance with the method according to the present invention. In particular FIG. 3 depicts examples of standard documents (tables) that make up the system and how those documents inter-relate.

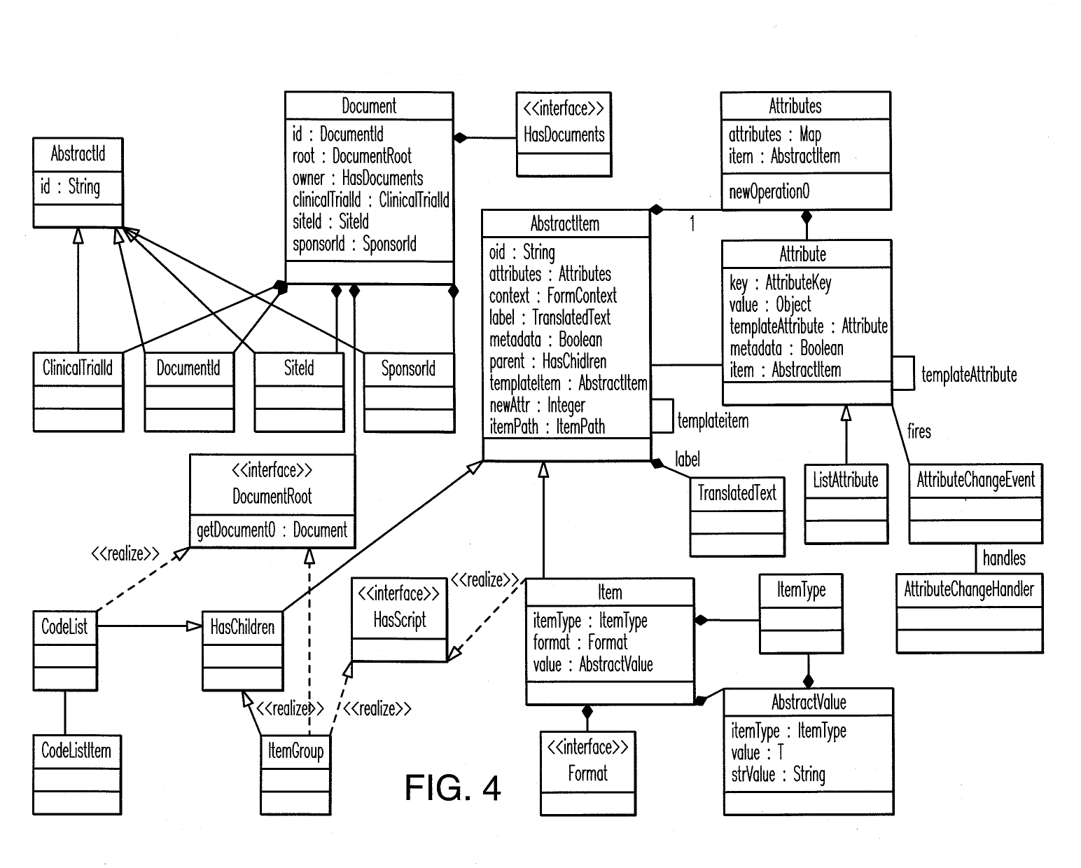

FIG. 4: illustrates how the metadata which describes the different documents, as illustrated in FIG. 3, is linked to different Entities. In particular FIG. 4 depicts examples of the metadata structure that is applied for forms configuration information inside the platform. This defines the structure allowing dynamic and nested forms to be persisted during runtime.

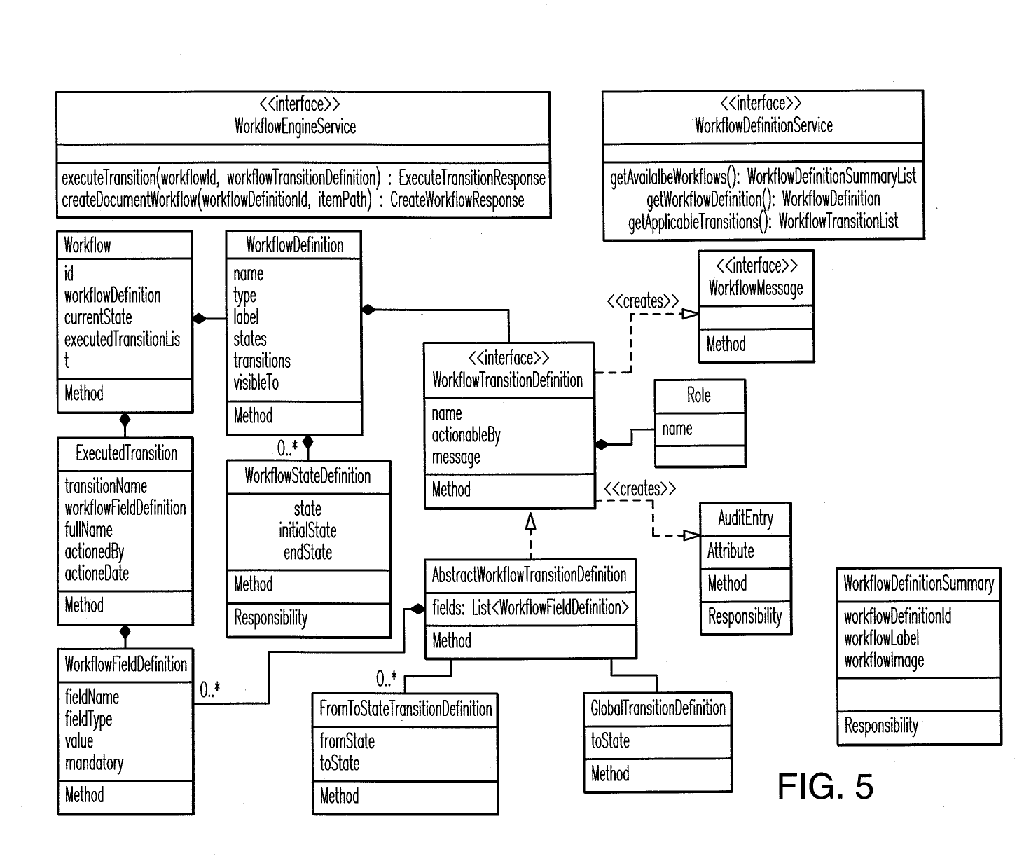

FIG. 5: illustrates how the Entity relationships illustrated in FIG. 3, support Workflow/Messaging components within the system for operating a clinical trial in accordance with the present invention. In particular FIG. 5 depicts examples of the workflow and message documents (tables) that hold the definition of workflows and how the workflows relate to roles and actions.

In accordance with another aspect there is provided a method according to any one or combination of the aspects defined herein and as independently illustrated in any of accompanying FIG. 2, 3, 4 or 5.

Embodiments of the Clinical Trial Facilitation Platform:
Site selection platform
Training platform
Recruitment platform
Electronic informed consent platform
Patient-screening platform
Electronic data capture system
Electronic web based patient reported outcome system
Multi-channel (patient, site, sponsor, regulator) Communication system
Automated or on demand reporting system
Clinical trial management platform
Data repository with access control
Patient database
Interactive Web Response (randomization) system

According to a further aspect there is provided use of the system according to any one or combination of the aspects herein for the provision of a system independently selected from: a system for provision of a training platform for pre-defined users in a clinical trial; a system for provision of a recruitment platform for identification of pre-defined potential subjects for participation in a clinical trial; a system for provision of an electronic informed consent platform for use in a clinical trial; a system for provision of a patient-screening platform for pre-defined users in a clinical trial; a system for provision of an electronic trial site master file (ETMF) for use in a clinical trial; a system for provision of a training platform for re-defined users in a clinical trial.

According to a further aspect still there is provided use of the system according to any one or combination of the aspects herein for the provision of a system independently selected from: provision of a data capture solution; a multi-channel communication system; an automated or on-demand reporting system; a clinical trial management system; a data repository with access control; an interactive Web Response System (IWRS); an electronic patient reported outcome solution.

In one embodiment the system may be used as a site selection platform where pre-defined users e.g. study sponsors, can message potential site investigators providing site selection tools like questionnaires. Responses are collected through the system and automated acceptance or rejection messages can be sent in return. In the case of acceptance the individual site staff members may then be directed to the eLearning function of the platform and individual training process can be tracked and certified. This embodiment may also be combined with any other system embodiment as defined herein.

In one embodiment the system can be used as a training platform. Pre-defined users can be presented with specific training materials and understanding can be tested in different forms of assessments e.g. multiple-choice questions, and results recorded in the system. Completion of training may allow the user to progress to other tasks. Other authorised user groups can review training progress, like time spent on individual training modules or which hyperlinks have been accessed. This embodiment may also be combined with any other system embodiment as defined herein.

In one embodiment the system can be used as a recruitment platform. Potential subjects may be identified through a number of different sources, which may be available on a local, regional, national or study-wide level, using a variety of web-based sources, including targeted advertisements on online search engines and health websites, online communities with a potential interest in a disease area, online patient advocacy groups, social media sites, and other websites, as well as from healthcare organizations, community based clinics, and commercial recruitment vendors. Potential subjects can access the platform remotely via the Internet and the platform collects relevant subject data as well as metadata like time and origin of access. Potential subjects may then be presented with screening tools like questionnaires, patient reported outcomes tools or other data requests, which the system can store and evaluate against pre-defined criteria. Completion of this process may allow the user to progress to other tasks. The system may also collate recruitment data on a local, regional or global basis, which can be reported manually or automatically to authorized users. This embodiment may also be combined with any other system embodiment as defined herein.

In one embodiment the system can be used as an electronic informed consent platform. Depending on the type of research and potential risks for the participants the informed consent process may necessitate several steps, which can all be performed on the platform. These steps may include viewing and listening to an online automated slide presentation or video recordings, a review of the full informed consent document on a participant facing interface, which may be at a remote location, different forms of assessments e.g. multiple-choice questionnaires, a validated signing process for the informed consent document, recordings of telephone or video call with study personnel, countersignatures from site staff. Other authorised user groups can review the progress, like time spent on individual modules or which hyperlinks have been accessed. Completion of the informed consent process may be stored and documented in the system and may allow the user to progress to other tasks. Other authorised users including site staff, monitors and auditors and regulators may access the system in real time. This embodiment may also be combined with any other system embodiment as defined herein.

In one embodiment the system can be used as a patient-screening platform. Pre-defined users can be presented with protocol specific screening tools like questionnaires, diaries and others. Responses to these screening tools are evaluated within the system and results are recorded in the system. The process may contain logic branching and may allow the user to progress to other tasks. All responses are captured with an audit trail and may be transferred to other modules on the platform including eCRFs or summary reports. Other authorised user groups can review the screening progress and get real-time access to summary data. This embodiment may also be combined with any other system embodiment as defined herein.

In one embodiment the system can be used as a clinical electronic trial site master file (ETMF), which allows for all relevant site related study documentation to be store in a single repository while allowing for specific documents like training records and others to be used for multiple studies. The system supports the storage of metadata form based electronic trial master file (eTMF) as well as the imported scanned image versions of documents. This embodiment may also be combined with any other system embodiment as defined herein.

In one embodiment the system can be used as a Data Capture solution offering the means to capture data from a variety of sources

The system allows the collection of data from an unlimited number of sources including electronic health records, ePROs, all kinds of medical devices, laboratory results and others. The system will then be able to present all or part of the data to pre-defined users in a variety of formats like electronic case report forms (eCRF) or in electronic standard format (CDISC ODM). This embodiment may also be combined with any other system embodiment as defined herein.

In one embodiment the system can be used as a multi-channel (patient, site, sponsor, regulator) Communication system. The system will allow authorised users to communicate with other individual users or user groups with a documented audit trail for these communications. The communications may include automated reminders for appointments or tasks, reporting of adverse events to sponsors, Institutional Review Boards, Ethics Committees, regulators or other parties, automated or manual alerts to individual user groups, study updates and information aimed at participant engagement and others. This embodiment may also be combined with any other system embodiment as defined herein.

In one embodiment the system can be used as an automated or on demand reporting system. Pre-defined users can receive automated time or target driven reports or request specific reports from the system. This may include local, regional or global recruitment, randomisation or completion reports for sites or sponsors, progress reports for participants, adverse event or protocol violation reports, drug compliance reports and others. These reports may trigger further actions or alerts. This embodiment also allows trial participants to obtain their personal trial data at the end of a study. If participants wanted access to this information, the system can send an electronic file containing their personal health information in a manner that is compliant with Health Insurance Portability and Accountability Act (HIPAA) guidelines and other appropriate regulations. This embodiment may also be combined with any other system embodiment as defined herein.

In one embodiment the system can be used as a clinical trial management platform. The system may be used to provide real time graphic illustrations of a variety of study progress parameters including site selection, training, approval or close out status, drug delivery status, tables or graphs of recruitment, randomisation or completion versus targets, comparisons of performance including recruitment, drop out rates, protocol violations, adverse events and others. All these illustrations can be done on a site, local regional or global level and may trigger further actions or alerts. This embodiment may also be combined with any other system embodiment as defined herein.

In one embodiment the system can be used as a data repository with access control. As there is a requirement for clinical source data to be archived often for many years all electronic study data may be stored in the system in a HIPAA/ compliant way with restricted access to pre-defined users. These reports may trigger further actions or alerts. This embodiment may also be combined with any other system embodiment as defined herein.

In one embodiment the system can be used as a patient database. As more and more patients participate in clinical studies patient demographic data may be stored in the system with the patient's permission and in a regulatory compliant way and used as a database for future recruitment into clinical studies. The patient database is accessible by a unique patient login that provides the means for them to opt in, and opt out of current and future assignment to availability for study enrolment. This embodiment may also be combined with any other system embodiment as defined herein.

In one embodiment the system can be used as an Interactive Web Response System (IWRS) to enable efficient and timely study medication distribution to the study site or to the patient. The system can also be configured to display drug supply levels on a site, country or global level and trigger re-supplies based on pre-defined criteria. This embodiment may also be combined with any other system embodiment as defined herein.

Whilst specific embodiments have been described herein in terms of preferred embodiments, further embodiments which relate to combinations of one or more of the specifically disclosed embodiments fall within the scope of the present invention.

In addition, where variations may be applied methods described herein without departing from the concept, spirit and scope of the invention which result in yet further embodiments, such yet further embodiments fall within the scope of the present invention.

1. A method for conducting a clinical trial using a system for operating the clinical trial, comprising the steps of:
a) receiving information;
b) obtaining input information in a pre-determined data structure;
c) extracting information from the input information within the data structure in order to draw an inference;
wherein the system is capable of uniting all stakeholders in a single instance model via utility of a combination of software, metadata and data wherein the system is capable of providing bespoke levels of privacy and security to one or more designated stakeholders all within a common single software instance and a common single database for all designated users, wherein users include patients and stakeholders.

2. A method according to claim 1, wherein the system provides a single system for all messaging, workflow and/or materials between stakeholders in a clinical trial.

3. A method according to claim 1, wherein the system is a domain specific platform and wherein clinical trial data can be accessed in real-time from the platform by the stakeholders in accordance with the bespoke privacy and security settings.

4. A method according to claim 1, wherein the system provides a dynamic organizational hierarchy supporting the acquisition of data.

5. A method according to claim 1, wherein the system provides the hierarchical instantiation of metadata across trials and organizations.

6. A method according to claim 1, wherein the system provides privacy protection for patient private data within the overall clinical trial data set as utilised by and accessible by sites and one or more of a sponsor(s).

7. A method according to claim 1, wherein patient private data is automatically redacted from any and all output formats including, but not limited to data capture forms, reports, data extracts and data integrations, and preferably wherein the system is a domain specific platform and wherein said redaction is automatic and visual redaction of patient private data from all data represented to user roles regardless of the method used to access that data.

8. A method according to claim 1, wherein any data entered into the system can be combined and compared with any other defined data set within the complete lifecycle of trial data available at the time of the combination/comparison request.

9. A method according to claim 1, wherein the system includes a user definable forms platform which enables messages and/or workflows to be designed in accordance with the requirements of the clinical trial.

10. A method according to claim 1, wherein the system includes a user definable forms platform which enables messages and/or workflows to be designed in accordance with the requirements of the clinical trial wherein the forms, workflow and messaging are based on configurable settings.

11. (canceled)

12. A method according to claim 1, further comprising the step of:
providing a system architecture which comprises the following components:
(i) one or more organisational components wherein each organisational component is configured to receive input from system, sponsor, collaborator, trial, document, and site components;
(ii) one or more sponsor components wherein each sponsor component is configured to receive/obtain input from one or more trial components, and wherein each sponsor component is configured to convert at least a portion of such input for extraction/access by the one or more organisational components;
(iii) a system component configured for data extraction/access by the one or more organisational components;
(iv) a trial component configured to receive/obtain input from one or more trial components and configured for data extraction/access by the one or more organisational components;
(v) one or more site components configured to provide input to one or more organisation components;
(vi) one or more user components linked to a document component; and
(vii) one or more family tree components linked to a document component.

13. The method according to claim 1, further comprising the step of: using the system according to claim 1 in a clinical trial independently selected from: a single-site trial; a multi-site trial or a virtual clinical trial wherein such trial ranges in size from an investigator sponsored trial (IST), up to a Mega-trial having two or more organisational tiers.

14. The method according to claim 1, further comprising the step of:
establishing a patient or volunteer registry.

15. The method according to claim 1, further comprising the step of:
providing a system independently selected from: a system for provision of a training platform for pre-defined users in a clinical trial; a system for provision of a recruitment platform for identification of pre-defined potential subjects for participation in a clinical trial; a system for provision of an electronic informed consent platform for use in a clinical trial; a system for provision of a patient-screening platform for pre-defined users in a clinical trial; a system for provision of an electronic trial site master file (ETMF) for use in a clinical trial; a system for provision of a training platform for re-defined users in a clinical trial.

16. The method according to claim 1, further comprising the steps of:
providing a data capture solution;
providing a multi-channel communication system;
providing an automated or on-demand reporting system;
providing a clinical trial management system;
providing a data repository with access control;
providing an interactive Web Response System (IWRS);
providing an electronic patient reported outcome solution.
